(19) United States
(12) Patent Application Publication
(10) Pub. No.: US 2024/0400007 A1
(43) Pub. Date: Dec. 5, 2024

(54) JACK HOLDER AND MOTOR VEHICLE

(71) Applicant: AUDI AG, Ingolstadt (DE)

(72) Inventors: Dominik PÜRZER, Reichertshofen (DE); Tobias BRAUN, Cleebronn (DE); Marcus DRECHSEL, Hepberg (DE); Carlo GOLD, Neuenstadt (DE); Hendrik RISCH, Neckarsulm (DE); Julian KÜKING, Bad Wimpfen (DE); Peter KÜLLER, Haßmersheim (DE); lgor NAGEL, Leingarten (DE)

(73) Assignee: AUDI AG, Ingolstadt (DE)

(21) Appl. No.: 18/645,819

(22) Filed: Apr. 25, 2024

(30) Foreign Application Priority Data
May 31, 2023 (DE) 102023114280.1

(51) Int. Cl. B60S 11/00

(52) U.S. Cl. CPC B60S 11/00

(57) ABSTRACT

A jack holder, including a base body and a fastening section projecting therefrom. The fastening section for fastening the jack holder is insertable along its longitudinal direction into a receptacle section of a body-fixed receptacle structure of a motor vehicle. The fastening section has at least one latching element which, with respect to an installation position in which the jack holder is fastened to the receptacle structure, interacts in a locking manner with the receptacle section to secure this fastening. At least one latching element is designed to be elastically resilient and/or is fastened to a main body of the fastening section in such an elastically resilient manner such that when the fastening section is inserted into the receptacle section, it elastically deflects and automatically springs back when the installation position is reached to form the locking mechanism.

### FIELD

The invention relates to a jack holder, comprising a base body and a fastening section projecting therefrom, wherein the fastening section for fastening the jack holder is insertable along its longitudinal direction into a receptacle section of a body-fixed receptacle structure of a motor vehicle, wherein the fastening section has at least one latching element, which, in relation to an installation position, in which the jack holder is attached to the receptacle structure, interacts in a locking manner with the receptacle section to secure this attachment. The invention furthermore relates to a motor vehicle.

### BACKGROUND

Jack holders are usually provided on the body of a motor vehicle to provide coupling points at which a jack or a lifting platform can be accommodated. Jack holders are usually fixed on the body in clip holes provided specially for this purpose or by screws and weld nuts.

DE 10 2017 100 624 A1 shows a jack holder that is fastenable to a support structure of a motor vehicle by means of a holding element by screws. By captively attaching the holding element to the jack holder so it is movable between multiple positions, its installation on the support structure is simplified.

In addition, DE 10 2020 134 082 B3 shows a jack holder having a base body made of a hard component to which a rubber component is attached. The jack holder is attached to a motor vehicle shell using screws and blind rivet nuts, wherein after the installation an opening of the motor vehicle shell can be sealed using the soft component.

Alternatively, DE 10 2006 008 306 B3 describes a locking mechanism of a jack holder on a body opening. The jack holder comprises a base body having protruding catch lugs that form a cylindrical fastening area. During installation, the catch lugs are inserted into the body opening, wherein in addition an expansion pin is driven into the fastening area in order to radially expand the catch lugs arranged in a circle and establish their locking mechanism with the body.

In any case, the use of screws, rivets or latching elements with an expansion pin represents complicated and complex fastening solutions for a jack holder on a body.

### SUMMARY

It is therefore the object of the present invention to provide an improved jack holder, which in particular enables simplified installation.

In order to achieve this object, in a jack holder of the type mentioned at the outset, it is provided according to the invention that the at least one latching element is designed to be elastically resilient and/or is fastened to a main body of the fastening section in an elastically resilient manner such that it deflects elastically when the fastening section is inserted into the receptacle section and automatically springs back when the installation position is reached to form the locking mechanism.

The receptacle structure can be a component, or a section, of a body of a motor vehicle or an additional part that is firmly fixed to the body, in particular by screwing and/or welding and/or riveting and/or punching. The receptacle section can be understood as meaning an area of the receptacle structure which has a suitable geometry, in particular one or more holes, into which the jack holder can be inserted with the fastening section for fastening on the body.

The jack holder comprises a base body, from which a fastening section protrudes, in particular linearly along the longitudinal direction. According to the invention, the fastening section has a main body and at least one latching element, wherein the main body and the at least one latching element can be a common, one-piece component or separate components. One or more latching elements can also be provided, which together with the main body form a common, one-piece component, wherein it is also provided that the remaining latching element or the remaining latching elements is or are fastened to the main body as separate component(s).

The at least one latching element can be pivoted or deflected into an interior of the fastening section in such a way that the latching element does not protrude beyond the outer contour of the main body. The interior of the fastening section can also be referred to as a cavity. To install the jack holder on the receptacle structure, the fastening section can then be inserted particularly easily in the longitudinal direction into the receptacle structure.

Due to the elastic design and/or connection of the at least one latching element, it can automatically spring back in the installation position without the application of force, i.e., without any other action. In the sprung-back state, the at least one latching element protrudes in areas over the outer contour of the main body of the fastening section, so that it forms a latching mechanism with the receptacle section in the installation position. In other words, the at least one latching element can form an undercut in the installation position on the receptacle section or the receptacle structure, by which the jack holder is firmly fixable to the receptacle structure. The jack holder can then possibly no longer be separated therefrom nondestructively.

The automatic springing back of the at least one latching element offers the advantage that no additional fastening means, for example screws, rivets, or expansion pins, are required to securely fasten the jack holder to the receptacle structure. Instead, the jack holder can simply be inserted into the receptacle structure in the longitudinal direction, in particular pressed in, which can save installation time. In other words, this provides a self-locking system in which the at least one latching element automatically latches in the installation position and enables a highly stable fastening to the receptacle structure. In relation to the prior art, this represents a significant simplification of the installation of the jack holder.

According to the invention, it is particularly preferred if the elastically resilient latching element is made of plastic, in particular of fiber-reinforced plastic, and/or that the latching element which is fastened to the fastening section in an elastically resilient manner is fastened to the fastening section by a spring element. Polypropylene filled with glass fibers is particularly suitable as a plastic, in particular polypropylene with a glass fiber content of approximately 30% (PP-GF30 in short). In addition, all other common plastics having corresponding elasticity properties that can preferably be processed by means of injection molding are conceivable. The plastic can additionally or alternatively be filled with other fibers, wherein the fiber content can also be greater or less than 30%. The plastic does not have to be reinforced by fibers. However, the fiber filling allows high mechanical strength to be achieved, wherein the weight still remains low. By means of the plastic, connection points at which the at least one latching element is connected to the main body of the fastening section can therefore be designed to be resilient and mechanically stable.

It is particularly advantageous if the base body having the fastening section and the at least one latching element is a component which is made of plastic, in particular a plastic having the properties described above. The entire jack holder can then be produced quickly and cost-effectively, preferably by injection molding in just one manufacturing process. Alternatively, it is conceivable that the jack holder is produced by multi-component injection molding, wherein, for example the plastic of the at least one catch lug differs from that of the base body and/or the fastening section. If the at least one latching element is subsequently fastened in an elastically resilient manner to the main body of the fastening section, this can be achieved, for example, by a leg spring or another suitable spring element.

An advantage with regard to the installation of the jack holder can be achieved if the at least one latching element tapers along the longitudinal direction of the fastening section with increasing distance from the base body, in particular in a parabolic shape. In other words, the longitudinal section of the at least one latching element tapers perpendicular to the longitudinal direction as the distance to the base body increases. The surface of the at least one latching element, which comes into contact with the receptacle section when the fastening section is inserted into the receptacle section, can be curved in the longitudinal direction. Alternatively, the surface can extend in a straight line in the longitudinal direction, wherein the at least one latching element in particular has a wedge shape in a longitudinal section. However, the at least one latching element preferably has the shape of a parabola in longitudinal section, specifically a half of a parabola.

When the fastening section is inserted into the receptacle section, the at least one latching element comes into contact with the receptacle section, so that the tapered shape of the at least one latching element causes the latching element to deflect automatically. This geometry allows an installation force that is required for inserting or pressing the jack holder into the receptacle section to be reduced. Particularly towards the end of the insertion process, the required installation force can be reduced in that the parabolic latching element projects less far than, for example, a linearly widening latching element. Specifically, the parabolic shape enables a reduction in installation force of up to 40% in relation to such linearly widening latching elements.

The dimensions of the outer contour of the main body of the fastening section are preferably selected so that they are only slightly smaller than an insertion opening of the receptacle structure into which the fastening section is inserted for installation on the jack holder on the motor vehicle. In order to insert the fastening section into the insertion opening and move the jack holder into the installation position, it is then necessary that the at least one latching element can deflect, in particular automatically, into the interior of the fastening section, since this would not fit into the insertion opening with the latching element in the sprung-back state. The insertion opening therefore represents a narrow point, which enables latching. During an insertion process of the fastening section into the insertion opening, the at least one latching element slides past the narrow point of the insertion opening, wherein its taper in the longitudinal direction automatically presses it, therefore deflects it, from the narrow point into the interior of the fastening section. If the fastening section is inserted into the insertion opening in the installation position at the end of the insertion process, the at least one latching element would be moved sufficiently far in the longitudinal direction, in particular completely, past the narrow point of the insertion opening, so that it can spring back by itself due to its elastic connection point to the main body. In this way, the at least one latching element can automatically lock with the receptacle structure in the installation position without any other action, by which a secure and firm connection of the jack holder to the receptacle structure or the body is possible.

The surface of the at least one latching element, which slides along the insertion opening during the insertion process, can also be curved in a cross section perpendicular to the longitudinal direction, i.e., with the longitudinal direction as the normal vector of the cross-sectional plane. This curvature can at least essentially correspond to the curvature or the contour of the insertion opening in the same cross section. In other words, the curvature of the surface of the at least one latching element can be modeled on the curvature of the insertion opening, and can therefore be curved, in particular arced or circular. This allows the at least one latching element to slide evenly along the insertion opening during the insertion process without one or more edges of the latching element digging into or cutting into the insertion opening.

Preferably, the surface of the at least one latching element, which slides along the insertion opening during the insertion process, is curved parabolically in longitudinal section along the longitudinal direction and is curved in cross section perpendicular to the longitudinal direction in such a way that it follows the curvature of the insertion opening.

In order to enable the jack holder to be securely locked on the receptacle section, the fastening section preferably has two latching elements. In this embodiment it is preferably provided that the two latching elements are arranged laterally opposite to one another on the main body of the fastening section. In relation to using only one latching element, the hold of the fastening section in the receptacle section can be improved using two or more latching elements. In particular, tilting of the fastening section in the receptacle section can be counteracted.

In a specific embodiment, the main body of the fastening section is cylindrical, wherein the center line or the longitudinal axis of the cylinder corresponds to the longitudinal direction. Two, three, four, or more latching elements are then connected to the main body, evenly distributed around the outer circumference of the cylinder. Due to the cylindrical shape, the fastening section can be inserted particularly easily into the receptacle structure, wherein uniform and secure locking takes place due to the latching elements evenly distributed on the outer circumference of the main body.

In order to further improve the fastening of the jack holder to the receptacle structure, in a further embodiment variant, in addition to the fastening section, at least one alignment pin projecting from the base body can be provided, which, when the fastening section is inserted into the receptacle structure, is inserted into at least one alignment opening of the receptacle structure and/or the body of the motor vehicle. The at least one, in particular elongated, alignment pin can extend away from the base body, in particular in the longitudinal direction, so that its orientation is at least substantially the same or identical to that of the fastening section. The at least one alignment opening can be a hole in the receptacle structure or in the body. By means of inserting the alignment pin into the alignment opening, it is ensured that the jack holder is brought into the required, or correct, orientation during installation on the receptacle structure. Because the jack holder has to engage in the at least one alignment opening in the installation position using the at least one alignment pin, twisting of the jack holder can be counteracted even if the main body of the fastening section is cylindrical. During the installation of the jack holder on the body, the fastening section is inserted into the insertion opening of the receptacle structure and at the same time the at least one alignment pin is inserted into the at least one alignment opening. As soon as the at least one alignment pin engages in the at least one alignment opening, all degrees of freedom of the jack holder, except for the movement of the jack holder in the longitudinal direction, are locked or canceled or blocked, except for any installation play. As soon as the jack holder is brought into the installation position and the at least one latching element is locked with the receptacle section, the movement in the longitudinal direction, i.e., the last remaining degree of freedom of the jack holder, is blocked or canceled.

One or more alignment pins can be provided on the base body, wherein all alignment pins preferably have the same geometry. To make it easier to insert the at least one alignment pin into the at least one alignment opening, it can taper as the distance from the base body increases, in particular to a tip.

The at least one alignment pin can also increase the shear load absorbable by the installed jack holder. Typically, jack holders are installed on the underbody side on a body of a motor vehicle in the vehicle vertical direction as the longitudinal direction. If these protrude from the underbody, they can become wedged on a curb when driving over a curb, for example, and can therefore be loaded in the vehicle transverse direction and/or in the vehicle longitudinal direction. The shear forces that occur, i.e., forces perpendicular or oblique to the longitudinal direction, would, if sufficient, result in the jack holder being sheared off from the body of the motor vehicle.

By additionally engaging one or more alignment pins in the receptacle structure and/or the body in addition to the fastening section, the engaging material cross section is enlarged, as a result of which greater shear forces are absorbed by the installed jack holder. It is therefore particularly advantageous if the main body of the fastening section and/or the at least one alignment pin engage in the receptacle structure and/or the body with the largest possible cross section perpendicular to the longitudinal direction. Preferably, two alignment pins arranged on opposite sides of the fastening section are therefore provided on the base body. Furthermore, each alignment pin is preferably free of cavities.

In a further preferred embodiment, the at least one latching element is designed such that it deflects into the cavity of the fastening section when the fastening section is inserted into the receptacle section. The at least one deflected latching element cannot protrude or can only partially protrude beyond the outer surface of the main body. Since the at least one latching element can move for deflection into the cavity or the interior of the fastening section, the cross section of the fastening section, in particular of the main body, can be only minimally smaller than an insertion opening of the receptacle structure that accommodates the fastening section. In this way, a particularly stable connection of the jack holder to the receptacle structure is achievable. The main body can be a hollow body, in particular a hollow cylinder, wherein the hollow interior of the main body forms the cavity.

In a refinement, the jack holder according to the invention can have a securing pin insertable into the cavity of the fastening section, wherein the cavity is at least partially, in particular completely, filled by the securing pin inserted there in order to increase the mechanical strength of the fastening section. The securing pin can preferably be insertable with a precise fit into the cavity of the fastening section. In other words, after the securing pin has been completely inserted, the cavity is preferably completely filled by the securing pin, so that there is a high mechanical strength of the fastening section, particularly with regard to a shear load. A cross section and stability increase of 10% to 20% is possible in this way.

The securing pin can also be produced from plastic by means of injection molding, wherein preferably the same plastic is used as in the jack holder. Alternatively, the securing pin can also be produced from metal, in particular aluminum.

The securing pin can be used not only to increase the mechanical strength of the fastening section. The securing pin can additionally be movable from a release position into a securing position, wherein the securing pin located in the securing position at least partially fills the cavity in such a way that the deflection of the at least one latching element which occurs when the fastening section is inserted into the receptacle section is blocked, wherein the securing pin located in the release position releases the area of the cavity into which the at least one latching element deflects in this case. In the securing position, the cavity can in other words be filled by the securing pin in such a way that the at least one latching element can no longer deflect therein. An unintentional loosening of the latching connection between the at least one latching element and the receptacle structure can thus be prevented. In the release position, the at least one latching element can still be moved into the cavity for deflection.

Preferably, the securing pin located in the release position is arranged captively within the remaining area of the jack holder. The securing pin can always be captively fixed to the jack holder, in particular in the cavity of the fastening section, both in the release and in the securing position. This can be made possible, for example, by a suitable geometry of the securing pin and the cavity. For example, the securing pin can have a cylindrical shaft having a circumferential shoulder, using which it is fixed in the release position in an internal groove of the likewise cylindrical cavity or the fastening section. The groove can also be provided on the shaft and the shoulder on the cavity or the fastening section. The shoulder forms a projection and the groove forms an, in particular opposite, undercut, wherein the shoulder and the groove form a locking mechanism. By applying sufficient force, in particular in the longitudinal direction, the fastening section can be deformed locally, in particular elastically, so that the undercut is overcome or the locking mechanism is released and the securing pin is movable into the securing position. Alternatively, the shoulder and/or the groove can be designed in such a way that the movement of the securing pin, in particular in the longitudinal direction, is released due to destruction when sufficient force is applied, so that, for example, the shoulder detaches or breaks off from the shaft in this case. Instead of a circumferential shoulder and a circumferential groove, any geometries lockable with one another and separable from one another again by applying force can be provided.

In addition, the securing pin preferably has at least one pin latching element, which automatically locks with a shoulder of the cavity in the securing position and blocks the securing pin from moving back in the longitudinal direction. In this way, the securing pin can always be protected against falling out of the cavity. The securing pin preferably has at least two pin latching elements which are arranged uniformly around a circumference of a cylindrical shaft of the securing pin. The at least one pin latching element can elastically deflect into a cavity or an interior of the securing pin, for example according to the principle explained above, in which the latching element deflects into the interior of the fastening section.

By means of this fixation, it is not necessary to provide the securing pin as an additional component. Instead, it can be handled as one component together with the jack holder, wherein it is particularly preferred if the securing pin does not protrude beyond the rest of the jack holder in any position. In this way, the external dimensions of the jack holder can be kept small, wherein at the same time multiple jack holders are prevented from becoming wedged due to protruding securing pins. Since the securing pin is also arranged in the securing position within the remaining area of the jack holder, it cannot represent a protruding obstacle when a jack or a lifting platform is applied.

In an advantageous refinement, the securing pin preferably comprises at least one cavity seal, which is in particular a sealing ring, wherein the cavity of the fastening section is sealed in a liquid-tight manner by the at least one cavity seal when the securing pin is in the securing position. The cavity seal, which consists in particular of an elastomer, can be an O-ring. A gap between the securing pin and the inner wall of the cavity can be sealed thereby, in particular in the securing position. In this way, after the jack holder has been installed, liquid and/or dirt can be prevented from entering the receptacle structure and/or the body. Alternatively, the cavity seal can be attached to the fastening section and seal towards the securing pin. Multiple cavity seals can also be provided, which are attached one behind the other in the longitudinal direction on the securing pin or on the fastening section.

In order to enable a good seal of the receptacle section and/or the body against dirt and/or liquid, it is advantageous if at least one body seal arranged on the base body is provided, which, when the jack holder is in the installation position, seals in a liquid-tight manner an area located between the jack holder and the receptacle structure, in which the insertion opening of the receptacle section is located. The insertion opening is the opening into which the fastening section engages in the installation position. The body seal is preferably a rubber seal, in particular made of elastomer. In particular, it is a sealing lip which is arranged circumferentially on a surface of the base body facing toward the motor vehicle in the installation position.

Advantageously, the jack holder, i.e., in particular the base body having the fastening section and the at least one alignment pin, is produced in one piece by means of injection molding, as already described. Here, the body seal can be inserted into the mold of the jack holder before the plastic is injected, wherein it is possible to fix the body seal, for example, by a form fit, in particular by back-injection. This means that no further fastening means or steps are required to fix the body seal. Except for the optionally provided locking pin, the entire jack holder can therefore be manufactured as one component in one process, which enables low manufacturing costs and time as well as a low component weight.

The body seal can also be used to compensate for installation play between the body and the jack holder in the longitudinal direction. By compressing the body seal between the body and the jack holder, the latter is pushed away from the body, wherein the jack holder is fixed to the receptacle structure in the installation position by the at least one latching element. In other words, the jack holder can be clamped to the body in the installation position, in particular in the longitudinal direction, by the at least one latching element and the body seal.

It is further preferred if the base body has a holding section, by means of which a holding part of a jack or a lifting platform can be coupled to the jack holder in such a way that the holding part and the jack holder are secured against slipping relative to one another in the coupled state. In this way, the jack holder and the jack or the lifting platform can be securely coupled to one another, wherein one of the two coupling partners is prevented from slipping or moving when coupled. The holding section and the holding part preferably have opposite shapes.

It is advantageous if the holding section is formed as a recessed area of the base body, which is arranged on a side of the base body opposite to the fastening section. The holding part can then engage in the holding section, in particular in a form-fitting manner. If the jack holder has a securing pin, this advantageously does not protrude into the recessed holding section in the securing position, in order not to obstruct the insertion of the holding part. Since the recessed holding section is part of the base body, it can be produced in the same injection molding process already described.

In order to facilitate removal of the jack holder from the body-fixed receptacle structure, the base body in a preferred embodiment has a guide template by means of which a drill can be guided to a connection point at which the at least one latching element is connected to the main body or a main body of the fastening section, in order to separate the at least one latching element from the main body by means of the drill. Since the at least one latching element springs back automatically, in particular in the installation position, and is difficult or impossible to access from the outside, the latching element usually has to be separated from the main body in order to remove the jack holder. This can be done by destroying the at least one connection point at which the at least one latching element is connected to the main body. In order to facilitate separating the at least one latching element, the jack holder preferably has the guide template. It can be a component of the base body or can be incorporated into the base body as an additional component, in particular as an injection-molded plastic part or as a metal part. For example, it can be inserted into the recessed fastening section for removal.

The guide template can have one or more guides through which the drill can be guided to the connection point of the at least one latching element on the main body. The guide can be an opening, in particular a guide hole, extending through the guide template. The guide can extend through the guide template along a direction, in particular obliquely, which points toward the connection point. The guide template preferably has a guide for each latching element.

In addition to the jack holder, the invention also relates to a motor vehicle having at least one body-mounted receptacle structure, wherein a jack holder according to the invention is installed on the at least one receptacle structure. The features, designs and advantages described for the jack holder according to the invention, in particular with regard to the installation and fixation of the jack holder on the receptacle structure, can be transferred to the motor vehicle according to the invention and vice versa.

It represents a particular advantage if the receptacle structure is fastenable using a fastening means of a transport device, so that the body held by the fastening means on the transport device can be transported by means of the transport device during manufacturing. The transport device can, for example, be a holder, in particular a gripping device, on which the body is hung and by which the body is moved through a manufacturing hall, like a conveyor belt. As a result, the receptacle structure already provided on the body, which otherwise only serves the purpose of holding the body of the motor vehicle on the transport device during production, can also be used to fasten the jack holder. This means that no additional holes or openings or other fasteners have to be made in the body to install the jack holder.

### BRIEF DESCRIPTION OF THE FIGURES

Further features, advantages and details of the present invention are explained below by means of specific exemplary embodiments and the figures. In the schematic figures:

FIG. 1 shows an exemplary embodiment of a motor vehicle according to the invention having jack holders according to the invention according to an exemplary embodiment,

FIG. 2 shows one of the jack holders of the motor vehicle of FIG. 1,

FIG. 3 shows a sectional view of the jack holder from FIG. 2 in a state mounted on a receptacle structure, wherein the plane of section extends along line III-III shown in FIG. 2,

FIG. 4 shows a sectional view of the jack holder from FIG. 2, wherein the plane of section extends along line IV-IV shown in FIG. 2,

FIG. 5 shows a sectional view of the jack holder from FIG. 2 with a securing pin in a release position, wherein the plane of section extends along line V-V shown in FIG. 2,

FIG. 6 shows a sectional view of the jack holder from FIG. 2 in a state mounted on a receptacle structure with a securing pin in a securing position, wherein the plane of section extends along line VI-VI shown in FIG. 2, and

FIG. 7 shows a sectional view of the jack holder from FIG. 2 with a guide template, wherein the plane of section extends along line IV-IV shown in FIG. 2.

### DETAILED DESCRIPTION

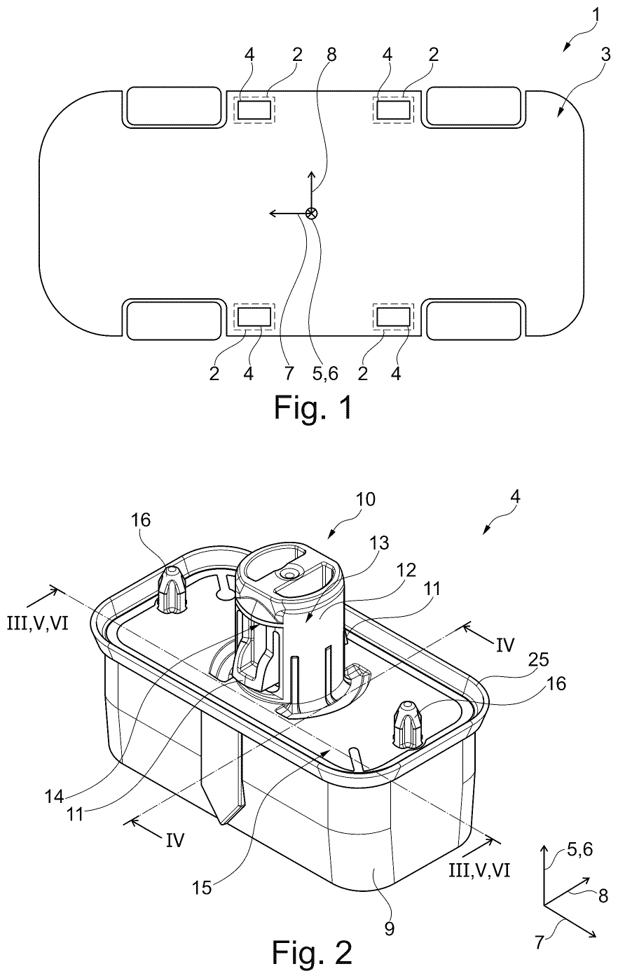

FIG. 1 shows schematically an exemplary embodiment of a motor vehicle 1 according to the invention, looking from below at its underbody. The motor vehicle 1 comprises four receptacle structures 2 (shown by dashed lines), which are firmly fixed to a body 3 of the motor vehicle 1 by means of welding. Alternatively, the receptacle structures 2 can also be fixed to a body 3 of the motor vehicle 1 by fastening means, such as screws or rivets. The receptacle structures 2 are configured to be attached to a fastening means of a transport device. The body 3 held on the transport device by the fastening means can then be transported through manufacturing by means of the transport device. Such a transport device can, for example, be a hanger, in particular a gripping device, of a conveyor belt, wherein the receptacle structures 2 are hanger receptacles.

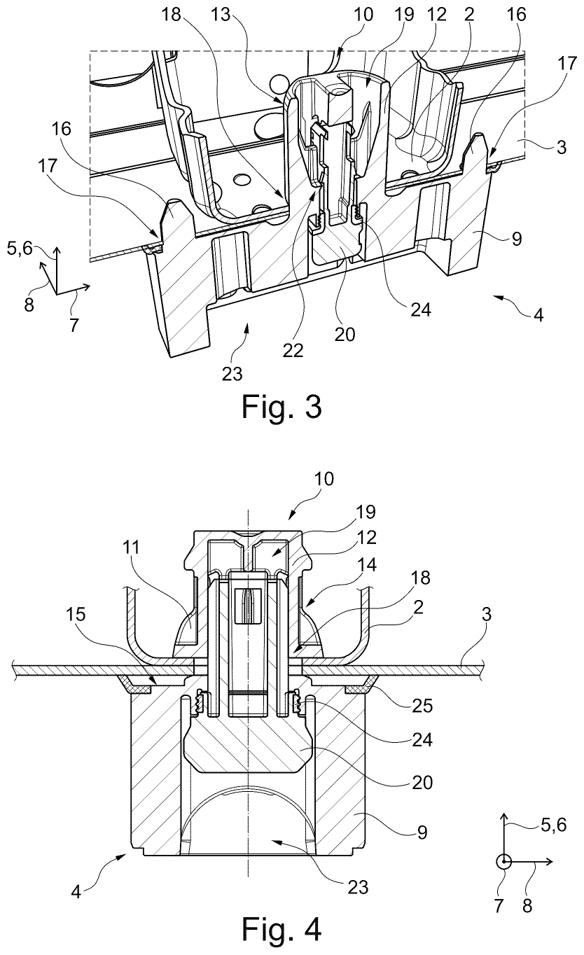

After the motor vehicle 1 has been manufactured, the receptacle structures 2 are usually no longer needed. However, as indicated in FIG. 1, they can be used for a robust fastening of jack holders 4 according to the invention to the body 3 of the motor vehicle 1. A jack holder 4 is installed on each receptacle structure 2, wherein the jack holder is inserted into one of the receptacle structures 2 for installation along a longitudinal direction 5, here a vehicle vertical direction 6. The simple insertion eliminates the need for additional parts and special tools. In addition, no additional holes or fastening structures have to be provided on the body 3, since these are already present on the receptacle structures 2. The fixation of the jack holder 4 on the receptacle structure 2 is described in more detail below, in particular with reference to FIGS. 3 and 6. For better orientation, a vehicle longitudinal direction 7 and a vehicle transverse direction 8 are also shown. For different motor vehicles 1, the size, number, and position of the receptacle structures 2 and the jack holders 4 (see FIG. 1) can vary.

FIG. 2 shows the basic structure of an exemplary embodiment of a jack holder 4 according to the invention. In FIGS. 3 and 4, the jack holder 4 is furthermore shown in the form of sectional views in an installation position in which it is fastened to the receptacle structure 2. The orientation of each of the sectional views can be seen in FIG. 2.

In FIG. 2 it can be seen that the jack holder 4 comprises a base body 9, from which a fastening section 10 having a cylindrical main body 12 protrudes in the longitudinal direction 5 for fastening to the receptacle structure 2. The fastening section 10 has two latching elements 11 for locking on the receptacle structure 2, which are arranged laterally, in the present case in the vehicle transverse direction 8, on opposite sides of the main body 12. The latching elements 11 and the main body 12 are in one piece and therefore together form the fastening section 10, which is implemented as a one-piece component. Alternatively, they can be attached to the main body 12 in an elastically resilient manner as additional parts, in particular each by a leg spring. Any number of latching elements 11, which are preferably arranged evenly distributed around the circumference of the cylindrical fastening section 10, can be formed on and/or attached to the fastening section 10.

If the fastening section 10 is inserted into the receptacle structure 2 in the longitudinal direction 5 for mounting the jack holder 4, the latching element 11 deflects into a cavity 13 of the fastening section 10. After reaching the installation position shown in FIG. 3 and FIG. 4, the latching element 11 automatically springs back and locks with the receptacle structure 2. The jack holder 4 is then firmly fixed on the receptacle structure 2, wherein the automatic springing back of the latching elements 11 enables installation by simple insertion into the receptacle structure 2.

The latching elements 11 are made of glass fiber reinforced plastic in order to enable a spring effect at their connection point 14 on the main body 12, wherein a sufficiently high mechanical strength is achieved at the same time by reinforcing the plastic using glass fibers. The glass fiber content here is 30%, wherein polypropylene is used as the plastic.

This exemplary selection of materials ensures that the latching elements 11 deflect slightly and spring back without the application of force. By means of the elastic connection to the main body 12, the latching elements 11 can spring back automatically. Except for inserting the fastening section 10 into the receptacle structure 2, no further action is required in order to lock the jack holder 4 with the latching elements 11 on the receptacle structure 2. In the sprung-back or locked state, the latching elements 11 protrude beyond an outer surface 13 of the cylindrical main body 12, due to which they form a stop to form an undercut.

The base body 8 and the fastening section 10, i.e., the main body 12 and the latching elements 11, are produced from the same plastic (PP-GF30 in short) as a contiguous, one-piece component. The production takes place in an injection molding process and is therefore particularly economical.

As FIG. 4 shows, the dimensions of the outer contour of the main body 12 of the fastening section 10 are only slightly smaller than an insertion opening 18 of the receptacle structure 2, into which the fastening section 10 is inserted for installation of the jack holder 4 on the motor vehicle 1. In order to insert the fastening section 10 into the insertion opening 18 and to move the jack holder 4 into the installation position, it is necessary that the latching elements 11 can deflect into the interior of the fastening section 10 or a cavity 19. The fastening section 10 would otherwise not fit into the insertion opening 18 with the latching elements 11 in the sprung-back state. The insertion opening 18 therefore represents a narrow point, which enables locking. During an insertion process of the fastening section 10 into the insertion opening 18, the latching elements 11 slide past the narrow point of the insertion opening 18, wherein they are automatically pressed into the cavity 19 by their parabolic longitudinal section from the narrow point and therefore deflect. If the fastening section 10 is inserted into the insertion opening 18 in the installation position at the end of the insertion process, the latching elements 11, as shown, automatically lock with the receptacle structure 2, by which a secure and firm connection of the jack holder 4 to the receptacle structure 2 or the body 3 is established.

In order to simplify the installation of the jack holder 4, the latching elements 11 each have a curved surface as a surface that comes into contact with the insertion opening 18 during the installation process. Due to the curvature of the surface, a small installation force is sufficient to press the jack holder 4 into the receptacle section 2. The surface of the latching elements 11 is parabolic in a longitudinal section that extends through the longitudinal direction 5. In FIG. 2 and FIG. 4 it is clear that the latching elements 11 taper along the longitudinal direction 5 with increasing distance from the base body 9 or from an end face 15 facing toward the receptacle structure 2 in the installation position. In other words, their cross section shrinks along the longitudinal direction 5 of the fastening section 10. Due to the parabolic shape of the latching elements 11, the required installation force can be reduced, particularly at the end of the installation process of the jack holder 4, i.e., when the fastening section 10 is inserted into the receptacle section. The reason for this is that in the case of the parabolic shape, a tangential angle of the surface of the latching element 11 in relation to the longitudinal direction 5 decreases as the distance to the end face 15 increases. As a result, the installation force can be reduced by approximately 40% in comparison to the case in which this surface tapers linearly.

In addition, the surface of individual, preferably all, latching elements 11 can be curved in an arc or circle in a cross-sectional plane perpendicular to the longitudinal direction 5, i.e., having the longitudinal direction 5 as the normal vector, so that the latching elements 11, during the insertion of the fastening section 10 into the insertion opening 18, do not dig or cut into the latter.

In addition, installation is simplified by alignment pins 16, which, like the fastening section 10, protrude from the base body 9 in the longitudinal direction 5 (see FIGS. 2 and 3). Because the main body 12 is cylindrical, the two alignment pins 16 are advantageous for fixing the jack holder 4 in a defined orientation on the receptacle structure 2 or the body 3. For this purpose, the alignment pins 16 are inserted into alignment openings 17 of the receptacle structure 2, or here the body 3, during installation. The alignment pins 16 engage in the alignment openings 17 at least approximately with a precise fit. By means of the alignment pins 16 engaging in the alignment openings 17, all degrees of freedom of the jack holder 4 can be blocked except for the movement in the longitudinal direction 5. After moving the jack holder 4 into the installation position and locking the latching element 11 on the receptacle structure 2, the movement in the longitudinal direction 5 can finally also be blocked, by which the jack holder 4 is firmly fixed to the body 3.

To align the jack holder 4, one alignment pin 16 is sufficient, but it is preferred to provide at least two or more alignment pins 16 in order to increase a material cross section using which the jack holder 4 engages in the receptacle structure 2 and the body 3 in the installation position. In this way, larger shear forces can be absorbed by the jack holder 4. Shear forces are understood to mean forces that act on the mounted jack holder 4 perpendicular to the longitudinal direction 5, in the present case thus in the vehicle longitudinal direction 7 and/or in the vehicle transverse direction 8. They can arise, for example, when the jack holder 4 collides with a curb.

In order to increase the engaging material cross section, the fastening section 10, in particular the main body 12, is also designed in such a way that it fits at least approximately with a precise fit into the insertion opening 18 of the receptacle structure 2, into which it is inserted in the longitudinal direction 5 for installation. The fastening section 10 therefore has the cavity 19 (see FIGS. 3-6), into which the latching elements 11 are pivotable for deflection, so that they do not protrude or only minimally protrude beyond the outer surface of the main body 12 and the cross section of the main body 12 approximately corresponds to the size of the insertion opening 18.

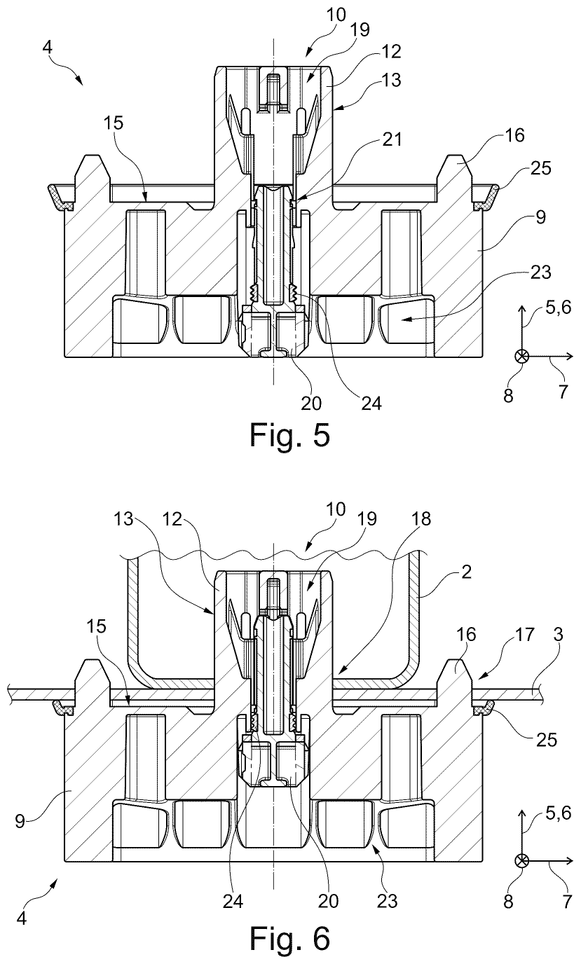

To fill the cavity 19, the jack holder 4 optionally has a securing pin 20, which is also produced by means of injection molding from plastic, in particular from the same plastic as the base body 9 of the jack holder 4. The securing pin 20 is displaceable in the cavity 19 from a release position (see FIG. 5), in which it minimally engages in the cavity 19, to a securing position (see FIG. 6), in which it at least approximately completely fills the cavity 19. By filling the cavity 19, the mechanical strength of the fastening section 10 is increased. In addition to increasing the material cross section of the jack holder 4 engaging in the receptacle structure 2, however, the securing pin 20 also blocks the deflection of the latching elements 11 into the cavity 19 in the securing position, by which their locking with the receptacle section 2 is additionally secured. In the release position, the deflection of the latching elements 11 into the cavity 19 is not blocked.

The securing pin 20 is captively attached to the jack holder 4 in the securing and release positions. Securing in the release position is achieved by a tongue-and-groove connection 21 (see FIG. 5) or an undercut. It prevents the securing pin 20 from falling out of the cavity 19. By applying force, the tongue and groove connection 21 can be overcome and the securing pin 20 can be brought into the securing position (see FIG. 6), in which it is also secured by an undercut 22 (see FIG. 3) is secured against falling out.

As FIG. 5 shows, the securing pin 20 does not protrude beyond the outer contour of the remaining jack holder 4 in the release position. This protects the securing pin 20 from damage and facilitates handling the jack holder 4. In the securing position shown in FIG. 6, the securing pin 20 also does not protrude into a holding section 23 of the jack holder 4. The holding section 23 is a recessed area of the base body 9 on the side of the jack holder 4, which is opposite to the fastening section 10. It is used to accommodate a holding part of a lifting platform or a jack, wherein it enables secure coupling of the holding part to the jack holder 4, which is secured against slipping or tilting of both parts in relation to one another. In order to be able to position the holding part more easily in the holding section 23 during coupling, the holding section 23 can be wedge-shaped in the longitudinal direction 5. For example, a coupling part of a jack can be inserted particularly easily into a wedge-shaped holding section 23 and coupled thereto, since geometry enables automatic centering of the coupling part in the holding section 23.

To seal the cavity 19, which would otherwise represent an opening in the receptacle structure 2 and the body 3 (see FIG. 6), the securing pin 20 has a cavity seal 24.

This is designed as a sealing ring and seals the cavity 19 in a liquid-tight manner when the securing pin 20 is positioned in the securing position. The cavity seal 24 is then positioned between the locking pin 20 and the wall of the cavity 19.

In order to prevent water and/or dust from entering through the insertion opening 18 and the alignment openings 17, the jack holder 4 additionally has a body seal 25, which is a sealing lip extending around the end face 15. It is fixed to the base body 9 and, in the installation position, seals the area between the jack holder 4 and the receptacle structure 2, in which the insertion opening 18 is located. In addition, as can be seen in FIG. 6, the receptacle openings 17 can also be sealed using the body seal 25. Any sealing lip suitable for motor vehicle construction can be used as the body seal 25. However, the body seal 25 is preferably a rubber seal. To fix it to the jack holder 4, the body seal 25 can be inserted into the mold in the injection molding process of the jack holder 4 before the beginning of the injection process. After the base body 9 has hardened, the body seal 25 is firmly fixed thereto, wherein the costs and effort of subsequently attaching the body seal 25 to the base body 9 can be avoided. By back-injecting the body seal 25 in areas, a formfitting connection to the base body 9 is also possible.

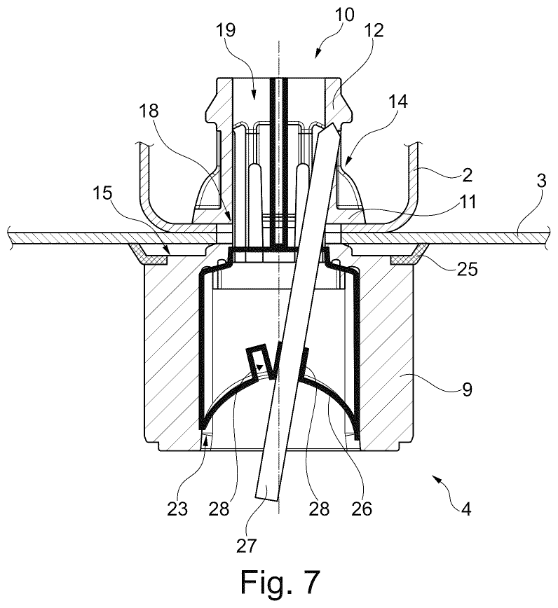

Since the latching elements 11 spring back automatically and are not accessible from the outside in the installation position, they cannot be deflected again to remove the jack holder 4 from the receptacle structure 2. The removal is therefore destructive, wherein the connection points 14 of the latching elements 11 on the fastening section 10 are severed. For this purpose, the base body 9 can have a guide template 26, using which a drill 27 can be guided to the connection points 14 in order to sever them. The guide template 26 is indicated in FIG. 7, which shows the sectional view of the jack holder 4 of FIG. 4. No securing pin 20 is provided in the jack holder 4 shown in FIG. 7. Instead, the guide template 26 is designed as part of the base body 9. It has two oblique guide projections 28 or guides, by means of which the drill 27 can be aligned so that the two connection points 14 of the latching elements 11 to the main body 12 can be severed using it. The drill 27 can thus be inserted with a diameter that preferably corresponds to the diameter of the respective guide projection 28 and is automatically aligned in such a way that when drilling is subsequently carried out by means of the drill 27, the tip of the drill automatically reaches the respective latching element 11 and separates it accordingly.

Because only guide projections 28 and no through holes are provided, the cavity 19 of the main body 12 is completely sealed by the guide template 26, so that in the installed state of the jack holder 4, neither liquid nor dirt can enter the interior of the body 3. Alternatively, the guide template 26 can be subsequently inserted as an additional part into the jack holder 4, in particular the holding section 23, in order to simplify removal. As long as the guide template 26 is not inserted into the jack holder 4, however, an additional seal is required to seal the cavity 19. The guide template 26 can also have a continuous opening (not shown here), which provides enough free space to also provide a securing pin 20 in addition to the guide template 26.

1. A jack holder, comprising a base body and a fastening section projecting therefrom, wherein the fastening section for fastening the jack holder is insertable along its longitudinal direction into a receptacle section of a body-fixed receptacle structure of a motor vehicle, wherein the fastening section has at least one latching element which, with respect to an installation position in which the jack holder is fastened to the receptacle structure, interacts in a locking manner with the receptacle section to secure this fastening,
wherein the at least one latching element is designed to be elastically resilient and/or is fastened to a main body of the fastening section in such an elastically resilient manner such that, when the fastening section is inserted into the receptacle section, it elastically deflects and automatically springs back when the installation position is reached to form the locking mechanism.

2. The jack holder according to claim 1, wherein the elastically resilient latching element is made of plastic, in particular of fiber-reinforced plastic, and/or in that the latching element fastened to the fastening section in an elastically resilient manner is fastened to the fastening section by a spring element.

3. The jack holder according to claim 1, wherein the at least one latching element tapers along the longitudinal direction of the fastening section with increasing distance from the base body, in particular in a parabolic shape.

4. The jack holder according to claim 1, wherein the fastening section has two latching elements which are arranged laterally opposite to one another on the main body of the fastening section.

5. The jack holder according to claim 1, wherein in addition to the fastening section, at least one alignment pin projecting from the base body is provided, which, when the fastening section is inserted into the receptacle structure, is inserted into at least one alignment opening of the receptacle structure and/or a body of the motor vehicle.

6. The jack holder according to claim 1, wherein the at least one latching element is designed such that when the fastening section is inserted into the receptacle section, it deflects into a cavity of the fastening section.

7. The jack holder according to claim 6, wherein a securing pin insertable into the cavity of the fastening section, wherein the cavity is at least partially, in particular completely, filled by the securing pin inserted therein to increase the mechanical strength of the fastening section.

8. The jack holder according to claim 7, wherein the securing pin is movable from a release position into a securing position, wherein the securing pin located in the securing position at least partially fills the cavity in such a way that the deflection of the at least one latching element, which occurs when the fastening section is inserted into the receptacle section, is blocked, wherein the securing pin located in the release position releases the area of the cavity into which the at least one latching element deflects in this case.

9. The jack holder according to claim 8, wherein the securing pin located in the release position is arranged captively within the remaining area of the jack holder.

10. The jack holder according to claim 7, wherein the securing pin comprises at least one cavity seal, which is in particular a sealing ring, wherein the cavity of the fastening section is sealed in a liquid-tight manner by the at least one cavity seal when the securing pin is in the securing position.

11. The jack holder according to claim 1, wherein at least one body seal arranged on the base body, which, when the jack holder is in the installation position, seals an area arranged between the jack holder and the receptacle structure, in which an insertion opening of the receptacle section is located, in a liquid-tight manner.

12. The jack holder according to claim 1, wherein the base body has a holding section by means of which a holding part of a jack or a lifting platform can be coupled to the jack holder such that the holding part and the jack holder are secured against slipping relative to one another in the coupled state.

13. The jack holder according to claim 12, wherein the holding section is designed as a recessed area of the base body which is arranged on a side of the base body opposite to the fastening section.

14. The jack holder according to claim 1, wherein the base body has a guide template by means of which a drill can be guided to a connection point at which the at least one latching element is connected to the or a main body of the fastening section, in order to separate the at least one latching element from the main body by means of the drill.

15. A motor vehicle having at least one body-fixed receptacle structure, wherein at least one jack holder according to claim 1 is installed on the at least one receptacle structure.

16. The motor vehicle according to claim 15, wherein the receptacle structure is fastenable using a fastening means of a transport device, so that the body held by the fastening means on the transport device can be transported during manufacturing by means of the transport device.

17. The jack holder according to claim 2, wherein the at least one latching element tapers along the longitudinal direction of the fastening section with increasing distance from the base body, in particular in a parabolic shape.

18. The jack holder according to claim 2, wherein the fastening section has two latching elements which are arranged laterally opposite to one another on the main body of the fastening section.

19. The jack holder according to claim 3, wherein the fastening section has two latching elements which are arranged laterally opposite to one another on the main body of the fastening section.

20. The jack holder according to claim 2, wherein in addition to the fastening section, at least one alignment pin projecting from the base body is provided, which, when the fastening section is inserted into the receptacle structure, is inserted into at least one alignment opening of the receptacle structure and/or a body of the motor vehicle.
